(19) United States
(12) Patent Application Publication
(10) Pub. No.: US 2006/0162105 A1
(43) Pub. Date: Jul. 27, 2006

(54) Cleaning brush for endoscopes

(75) Inventor: Masanao Abe, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/326,473

(22) Filed: Jan. 6, 2006

(30) Foreign Application Priority Data
Jan. 7, 2005 (JP) 2005-003224

(51) Int. Cl. B08B 9/04

(52) U.S. Cl. 15/104.2

(57) ABSTRACT

A cleaning brush for endoscopes is used for cleaning an inner surface of a channel formed inside an endoscope and it is capable of preventing splash of dirt or cleaning liquid caused by removing a brush portion from a channel reliably. The cleaning brush includes an elongated body portion having flexibility so as to be able to bend along an inner wall of the channel when being inserted into the channel, at least one brush portion provided on the body portion at the side of the tip end thereof; and a protruding portion provided on the body portion so as to protrude from the tip end of the body portion in a longitudinal direction thereof, the protruding portion being adapted to make contact with the inner surface of the channel to prevent or suppress the brush portion from swinging or springing when the brush portion is removed from the channel, wherein the length of the protruding portion is longer than the length of the brush portion.

### BACKGROUND OF THE INVENTION

1. Field of the Invention

The present invention relates to a cleaning brush for endoscopes that cleans the inside of a channel formed in an endoscope.

2. Description of the Prior Art

An endoscope for observing the inside of human body is provided with various channels such as a treatment instrument insertion channel into which a treatment instrument such as a forceps or the like is to be inserted, a suction channel for suctioning body fluid and the like which may be obstacle to observation to discharge it to the outside of the human body, a water supply channel, an air supply channel and the like. A cleaning brush for endoscopes is used for cleaning (removing dirt, dust and the like) the inside of these channels after using the endoscope. As for one example of a cleaning brush for endoscopes, a cleaning brush disclosed in JP-A No. 2002-563 is known (See FIG. 8).

As shown in FIG. 8, a cleaning brush 40 for endoscopes (hereinafter, simply referred to as “a cleaning brush 40”) has an elongated flexible shaft (body portion) 41 and a plurality of brush portions 52. Each of the brush portions 52 is formed into a substantially cylindrical shape, and they are provided on the tip end side of the flexible shaft 41 with a predetermined space therebetween. Since the outer diameter of each of the brush portions 52 in a natural state is set so as to be larger than the inner diameter of each channel, the brush portions 52 come into contact with the inner wall (inner surface) of the channel when the brush portions 52 are inserted into the channel.

When using the cleaning brush 40 having such a structure, a base end portion 41a of the flexible shaft 41 in which part the brush portions 52 are not provided is inserted into the channel of the endoscope from one end of the channel toward the other end thereof, and then the cleaning brush 40 is further pushed into the channel. When the base end portion 41a protrudes from the other end of the channel, the cleaning brush 40 is removed from the channel by pulling the base end portion 41a. In this process, the inner wall of the channel is cleaned with the brush portions 52. In this way, the endoscope is cleaned using the cleaning brush 40. In particular, each of the brush portions 52 scrapes out dirt and the like adhering to the inner wall of the channel to clean the channel. Generally, such cleaning is carried out in a state that each of the brush portions 52 is impregnated with cleaning liquid for improving cleaning effect.

However, in the conventional cleaning brush 40 having the above structure, there is the following problem. Namely, in the conventional cleaning brush 40, when one of the brush portions 52 which is positioned nearest to the tip end of the flexible shaft 41 (namely, the last brush portion to be removed from the channel) is removed from the channel, the brush portions 52 (that is, a part of the flexible shaft 41) swing or spring due to the resiliency of the flexible shaft 41 and the elasticity of the brush portion removed at last since they are released from the restraint by the inner wall of the channel. When such swinging or springing of the brush portions 52 occur, dirt scraped out by the brush portions 52 and cleaning liquid carried by the brush portions 52 are splashed to a user who carries out cleaning. This may cause contamination or disease infection.

### SUMMARY OF THE INVENTION

In view of the above problem, it is an object of the present invention to provide a cleaning brush for endoscopes which can prevent or suppress splash of dirt or cleaning liquid reliably when removing a brush portion from a channel.

In order to achieve the above object, the present invention is directed to a cleaning brush for endoscopes for cleaning a channel formed inside an endoscope. The cleaning brush comprises an elongated body portion having flexibility so as to be able to bend along an inner wall of the channel when being inserted Into the channel, the body portion having a tip end and a base end, at least one brush portion provided on the body portion at the side of the tip end thereof, and a protruding portion provided on the body portion so as to protrude from the tip end of the body portion in a longitudinal direction thereof, the protruding portion being adapted to make contact with the inner surface of the channel to prevent or suppress the brush portion from swinging or springing when the brush portion is removed from the channel.

According to the cleaning brush having such a structure, the protruding portion is still in contact with an inner wall of the channel after the brush portion has been removed from the channel, whereby enabling to prevent the brush portion from suddenly jumping out of the channel due to the resiliency of the body portion and the elasticity of the brush portion itself, namely enabling to prevent the brush portion from swinging or springing. Accordingly, it is possible to prevent or suppress splash of dirt scraped out by the brush portion or cleaning liquid carried by the brush portion to a user reliably.

In the cleaning brush for endoscopes according to the present invention, it is preferred that the at least one brush portion includes a plurality of brush portions, in which the length of the protruding portion is substantially equal to longer than the length of one of the brush portions which is positioned nearest to the tip end among the plurality of brush portions.

This makes it possible to prevent or suppress splash of dirt or cleaning liquid more reliably.

In the cleaning brush for endoscopes according to the present invention, it is also preferred that the length of the protruding portion is in the range of 100 to 1000% of the length of the brush portion positioned nearest to the tip end.

By setting the length of the protruding portion to a value within the above range, it becomes possible to prevent or suppress splash of dirt or cleaning liquid more reliably.

In the cleaning brush for endoscopes according to the present invention, it is also preferred that the average outer diameter of the protruding portion is smaller than that of the body portion.

This assures that the protruding portion has sufficient flexibility so as to be able to absorb the shock generated at the time of contacting with the inner wall of the channel, namely the protruding portion can make contact with the inner wall of the channel softly when removing the brush portion from the channel. Therefore, it becomes possible to prevent or suppress the swinging or springing of the brush portion more reliably, whereby enabling to prevent or suppress splash of dirt or cleaning liquid more reliably.

In the cleaning brush for endoscopes according to the present invention, it is also preferred that the outer diameter of the protruding portion is reduced gradually toward the tip end thereof.

This also assures that the protruding portion has sufficient flexibility so as to be able to absorb the shock generated at the time of contacting with the inner wall of the channel, namely the protruding portion can make contact with the inner wall of the channel softly when removing the brush portion from the channel. Therefore, it becomes possible to prevent or suppress the swinging or springing of the brush portion more reliably, whereby enabling to prevent or suppress splash of dirt or cleaning liquid more reliably.

In the cleaning brush for endoscopes according to the present invention, it is also preferred that stiffness of the protruding portion is lower than that of the body portion.

This also assures that the protruding portion has sufficient flexibility so as to be able to absorb the shock generated at the time of contacting with the inner wall of the channel, namely the protruding portion can make contact with the inner wall of the channel softly when removing the brush portion from the channel. Therefore, it becomes possible to prevent or suppress the swinging or springing of the brush portion more reliably, whereby enabling to prevent or suppress splash of dirt or cleaning liquid more reliably.

In the cleaning brush for endoscopes according to the present invention, it is also preferred that at least a part of the protruding portion is integrally formed with the body portion.

According to this, it is not necessary to provide the protruding portion on the body portion as a separate member, whereby enabling to simplify the manufacturing process of the cleaning brush.

In the cleaning brush for endoscopes according to the present invention, it is also preferred that the protruding portion is provided with friction increase means for increasing friction between the protruding portion and the inner surface of the channel.

By providing the friction increasing means as described above, it becomes possible to prevent the protruding portion from suddenly jumping out of the channel when removing the entire cleaning brush from the channel, whereby making it possible to prevent or suppress splash of dirt or cleaning liquid more reliably.

In the cleaning brush for endoscopes according to the present invention, it is also preferred that the friction increase means is comprised of fine irregularities or a rubber coating provided on the outer surface of the protruding portion.

Such friction increase means can be provided in the protruding portion easily.

In the cleaning brush for endoscopes according to the present invention, it is also preferred that the base end portion of the body portion functions as a grasping portion to be grasped by a user.

The grasping portion allows a user to hold the cleaning brush easily and reliably, thus making it possible to improve the operability of the cleaning brush.

These and other objects, structures and results of the present invention will be apparent more clearly when the following detailed description of the preferred embodiments is considered taken in conjunction with the appended drawings.

### BRIEF DESCRIPTION OF THE DRAWINGS

FIG. 1 is a plane view showing an endoscope to which a cleaning brush for endoscopes according to the present invention is to be used.

FIG. 2 is a plane view showing a first embodiment of the cleaning brush for endoscopes according to the present invention.

FIG. 3 is a partial cross sectional view which shows a state that the cleaning brush for endoscopes shown in FIG. 2 is actually used.

FIG. 4 is a partial cross sectional view which shows a subsequent state that the cleaning brush for endoscopes shown in FIG. 2 is actually used.

FIG. 5 is a plane view showing a second embodiment of the cleaning brush for endoscopes according to the present invention.

FIG. 6 is a plane view showing a third embodiment of the cleaning brush for endoscopes according to the present invention.

FIG. 7 is a plane view showing a fourth embodiment of the cleaning brush for endoscopes according to the present invention.

FIG. 8 is a plane view showing a conventional cleaning brush for endoscopes.

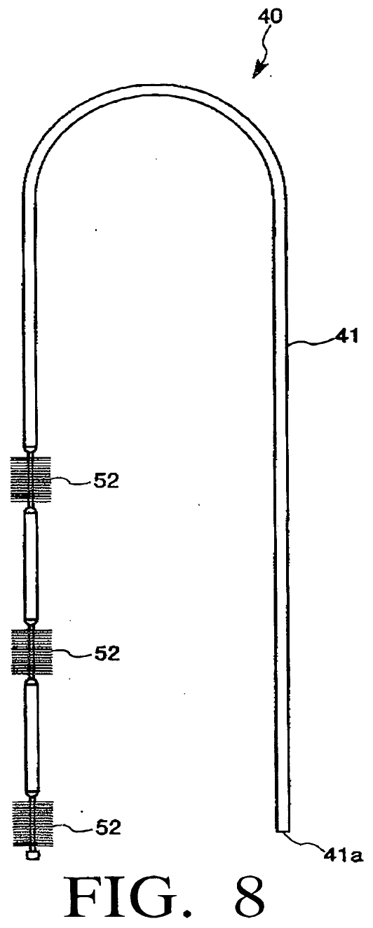

### DETAILED DESCRIPTION OF THE INVENTION

Hereinafter, a cleaning brush for endoscopes according to the present invention will be described in detail based on preferred embodiments shown in the appended drawings.

### <FIRST EMBODIMENT>

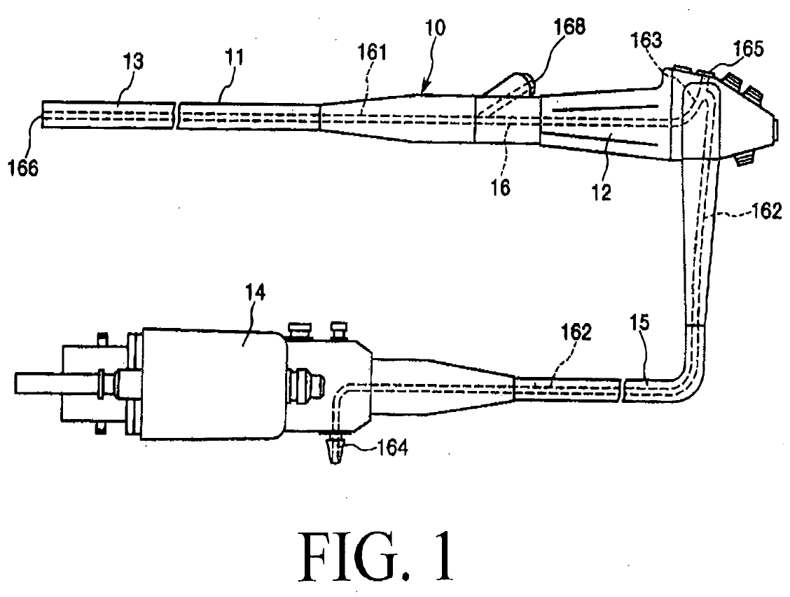

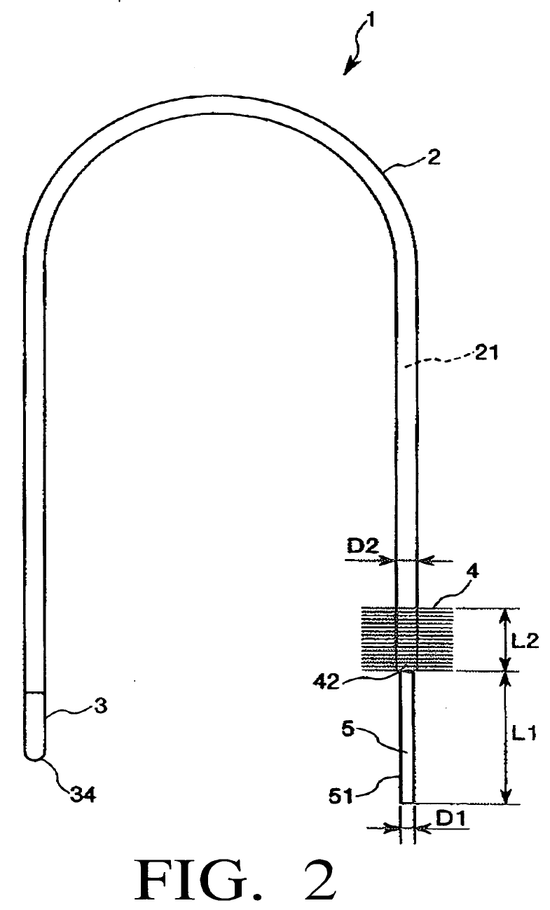

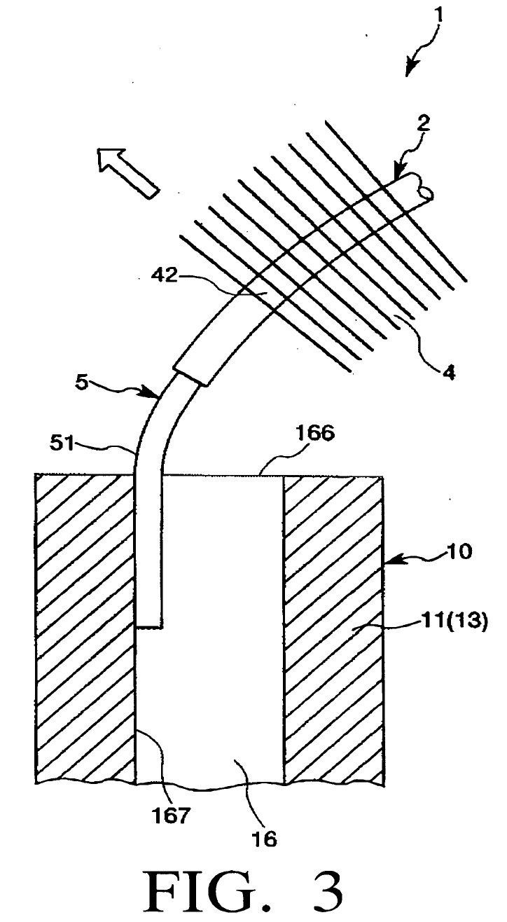

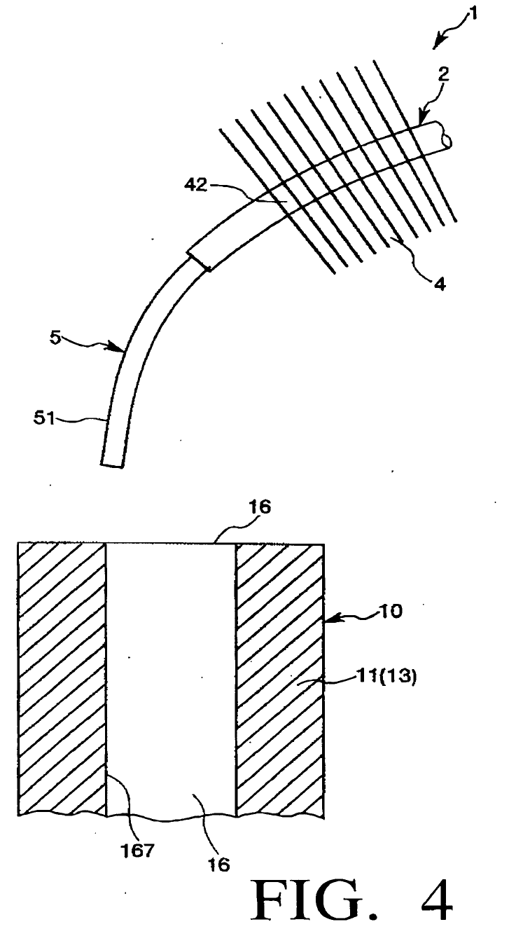

FIG. 1 Is a plane view showing an endoscope to which a cleaning brush for endoscopes according to the present invention is to be used, FIG. 2 is a plane view showing the first embodiment of the cleaning brush for endoscopes according to the present invention, FIG. 3 is a partial cross sectional view which shows a state that the cleaning brush for endoscopes of the first embodiment is actually used, and FIG. 4 is a partial cross sectional view which shows a subsequent state that the cleaning brush for endoscopes of the first embodiment is actually used. In this regard, it is to be noted that in the cleaning brush for endoscopes 1 shown in FIG. 2 an end portion having a brush portion is referred to as “a tip end” and the other end is referred to as “a base end” in the following description.

First, one example of an endoscope will be described based on FIG. 1.

An endoscope 10 shown in FIG. 1 is an electronic endoscope which is generally composed from an elongated flexible tube (insertion section) 11, an operating section 12 provided on the base end of the flexible tube 11 so as to be held by an operator for operating the endoscope 10, a bendable portion 13 provided on the tip end of the flexible tube 11 so that its bending state can be remotely controlled by the operating section 12, a light source plug 14 to be connected to a light source processor apparatus (not shown in the drawings), and a connecting flexible tube 15 for connecting the operating section 12 and the light source plug 14. Inside the endoscope 10, there are provided a light guide comprised of a bundle of optical fibers, cables such as an image signal cable, tubes such as a water supply tube and the like.

When using the endoscope 10, light emitted from a light source in the light source processor apparatus is guided to the tip end portion of the bendable portion 13 through the light guide, and then the light is radiated from the tip end portion to a portion to be observed to light up or illuminate the observed portion.

An image pickup device (CCD) (not shown in the drawings) for taking an image of the observed portion is provided in the tip end portion of the bendable portion 13. An image signal of the subject image produced by the image pickup device is transmitted to the light source processor apparatus via the image signal cable and then inputted into a monitoring device (not shown in the drawings) after being subjected to a predetermined process. In the monitoring device, an image (an electronic image) taken by the image pickup device is displayed in the form of a motion picture.

In the inside of such an endoscope 10, there are provided various types of channels such as, for example, a treatment instrument insertion channel into which a treatment instrument such as a forceps and the like is to be inserted, a suction channel for suctioning body fluid and the like which may be an obstacle to observation to discharge it to the outside of the endoscope 10, a water supply channel, an air supply channel and the like. The cleaning brush for endoscopes according to the present invention are used for cleaning these various kinds of channels. Hereinbelow, a description will be made with regard to a representative case where the cleaning brush is used for cleaning a suction channel 16.

The suction channel 16 is formed from a tube 161 continuously arranged inside the bendable portion 13, the flexible tube 11 and the operating section 12, a tube 162 continuously arranged inside the light source plug 14 and the connecting flexible tube 15, a cylinder portion 163 having a cylindrical shape and provided in the operating section 12, and a suction nipple 164 provided on the light source plug 14.

In the operating section 12, the tube 161 is connected to the bottom portion of the cylinder portion 163 while the tube 162 is connected to the side portion of the cylinder portion 163. Namely, the tube 161 and tube 162 are communicated with each other through the cylinder portion 163.

When using the endoscope 10, a suction pump (not shown in the drawings) is connected to the suction nipple 164, whereby suctioning a suctioning object from an opening (a tip opening) provided in the tip end portion of the bendable portion 13 through the tube 161, the cylinder portion 163 and the tube 162.

In the cylindrical portion 163, there is provided a suction controlling valve (not shown in the drawings) for controlling an ON/OFF state of the suction operation when using the endoscope 10. When cleaning the suction channel 16, the suction controlling valve is removed to open the top portion of the cylinder portion 163 (that is, the opening 165 is opened).

In this regard, it is needless to say that the cleaning brush 1 for endoscopes according to the present invention can be used not only for an electronic endoscope such as the endoscope 10, but also for various kinds of endoscopes such as a fiber endoscope and the like.

Next, the cleaning brush 1 for endoscopes (hereinafter, simply referred to as “the cleaning brush 1”) will be described in detail.

The cleaning brush 1 shown in FIG. 2 is a brush for cleaning the inside of channels such as a treatment instrument insertion channel, a suction channel, a water supply channel, an air supply channel and the like which are provided in the endoscope 10 (namely, removing dirt, dust and the like staying inside the channel) after using the endoscope 10.

As shown in FIG. 2, the cleaning brush 1 includes an elongated body portion 2 having flexibility, one brush portion 4 provided on the body portion 2 at the side of the tip end thereof, and a protruding portion 5 which protrudes in a longitudinal direction of the body portion 2 from a tip end portion 42 of the brush portion 4.

The body portion 2 is constructed so as to be able to bend along the inner wall of the suction channel 16 when being inserted into a curved portion of the channel.

Further, it is preferred that the body portion 2 has certain degree of bending stiffness and twisting stiffness. This makes it possible to transmit pushing force or twisting force applied from the base end portion to the tip end portion (brush portion 4) efficiently, whereby enabling the cleaning brush 1 to move forward or backward easily inside the channel.

In the present embodiment, the body portion 2 is formed from an elongated tubular member (hollow member) made of a synthetic resin. This assures that the body portion 2 has certain degree of bending stiffness and twisting stiffness while enabling to reduce the sliding resistance of the body portion 2 against the inner surface of the channel, whereby making it possible to obtain superior operability.

A synthetic resin constituting the body portion 2 is not particularly limited to any specific one, but polypropylene (PP) or polyethylene is preferably used, in particular high-density polyethylene. polytetrafluoroethylene (PTFE), polyethylene terephthalate (PET), polyester elastomer or the like is preferably used.

Further, a hollow portion 21 of the body portion 2 may be provided with a reinforcing member (core member) which is made of various metal materials, resins having relatively high hardness or the like.

Furthermore, the structure of the body portion 2 is not limited to the above-mentioned one. The body portion 2 may be formed from a solid member, a coil-shaped (spiral) member, a member obtained by bundling or twisting a plurality of line elements, or a combination of these members.

Moreover, the constituent material of the body portion 2 is not limited to a synthetic resin, and the body portion 2 may be formed from various metal materials such as stainless steel, aluminum, aluminum alloy, titanium, titanium alloy, copper, copper alloy, or the like.

In addition, the length of the body portion 2 is appropriately set according to the length of the channel of the endoscope 10 to be used. Practically, it is preferred that the length of the body portion 2 is in the range of 800 to 2,500 mm.

A grasping portion 3 is provided on the body portion 2 at the base end side thereof. The grasping portion 3 is adapted to be grasped by a user when using the cleaning brush 1. By providing such a grasping portion 3, the cleaning brush 1 can be grasped easily so that the operability of the cleaning brush 1 inserted into or placed inside the channel can be improved.

The grasping portion 3 is a cylindrical member having a diameter smaller than that of the body portion 2, and a base end 34 thereof is formed into a hemispherical shape. Since the grasping portion 3 has the base end 34 having such a hemispherical shape, it is possible to handle the cleaning brush 1 smoothly when inserting it into the channel from the base end 34. Further, it is preferred that the length of the grasping portion 3 is set so that a user can hold the grasping portion 3 with his fingers.

In this regard, it is to be noted that the materials described above with reference to the body portion 2 can also be used as a constituent material of the grasping portion 3.

Further, a predetermined color may be given to the surface of the grasping portion 3. This assures that when the grasping portion 3 comes to protrude from the opening 166 a user can immediately confirm that the base end portion of the cleaning brush 1 has reached the opening 166, whereby enabling to clean the endoscope efficiently.

The brush portion 4 has a cylindrical shape as a whole. The brush portion 4 is composed of a large number of line elements which form bristles of the brush portion 4, and a base portion of each of the line elements is fixed to the body portion 2. The line elements can be fixed to the body portion 2 by means of adhesion (adhesion with adhesive or solvent), fusion (fusion by heat, high frequency, ultrasound or the like) and the like. This makes it possible to connect or fix the brush portion 4, that is each line element of the bristles, to the body portion 2 firmly, thus enabling to prevent the bristles from being detached or fallen out from the body portion 2 and remaining inside the channel reliably.

Further, the outer diameter of the brush portion 4 in its natural state is set so as to be larger than the inner diameter of the channel. This makes it possible for the bristles of the brush portion 4 to make contact with the inner wall of the channel reliably when inserting the brush portion 4 into the channel to scrape out dirt adhering to the inner wall of the channel.

Furthermore, the brush portion 4 is impregnated with cleaning liquid in advance of cleaning inside the channel. The cleaning liquid can promote detachment of dirt adhering to the inner wall of the channel, thus making It possible to scrape out the dirt more reliably. Examples of the cleaning liquid include neutral, alkaline or acidic cleaning liquid and the like.

Moreover, the constituent material of the bristles of the brush portion 4 is not limited to any specific material as long as it has elasticity. Examples of the constituent material of the bristles of the brush portion 4 include various kinds of resin materials, metal materials and the like. Among these materials, it is particularly preferable to use nylon, polyurethane, polypropylene, polyethylene, polyvinylchloride and the like.

The protruding portion 5 is formed from a cylindrical member which is coupled to the tip end of the body portion 2. The length of the protruding portion 5 (the length indicated by L1 in FIG. 2) is set so as to be longer than the length of the brush portion 4 (the length indicated by L2 in FIG. 2). Practically, the length of the protruding portion 5 is set to be in the range of 100 to 1000% of L2.

Due to the provision of the protruding portion 5 described above, even in a case where the brush portion 4 is removed from the opening 166 after cleaning the suction channel 16, the protruding portion 5 can still remain inside the suction channel 16 for a predetermined period of time (see FIG. 3). Namely, the protruding portion 5 is still in contact with the inner wall 167 of the suction channel 16 after the brush portion 4 has been removed from the opening 166, whereby enabling to prevent the brush portion 4 from suddenly jumping out of the opening 166 due to the resiliency of the body portion and the elasticity of the brush portion 4 itself, namely prevent the brush portion 4 from swinging or springing, that is, moving to the direction indicated by an arrow in FIG. 3 (See FIG. 4).

Such function of the protruding portion 5 makes it possible to prevent or suppress splash of dirt scraped out by the brush portion 4 or cleaning liquid carried by the brush portion 4 to a user reliably.

In this regard, it is to be noted that a material having hardness (stiffness) lower than that of the body portion 2 is preferably used as a constituent material of the protruding portion 5.

Such a constituent material gives the protruding portion 5 sufficient bendability (flexibility) so as to be able to make contact with the inner wall 167 of the suction channel 16 softly when removing the brush portion 4 from the opening 166. Accordingly, it is possible to prevent or suppress the swinging or springing of the brush portion 4 more reliably, namely to prevent or suppress splash of dirt or cleaning liquid more reliably.

Further, the average outer diameter of the protruding portion 5 (the length indicated by D1 in FIG. 2) is set so as to be smaller than that of the body portion 2 (the length indicated by D2 in FIG. 2). This also assures that the protruding portion 5 has flexibility so as to be able to make contact with the inner wall 167 of the suction channel 16 softly when removing the brush portion 4 from the opening 166, whereby making it possible to prevent or suppress the swinging or springing of the brush portion 4 more reliably, namely to prevent or suppress splash of dirt or cleaning liquid more reliably.

In this regard, it is to be noted that the connection of the protruding portion 5 to the body portion 2 may be carried out by adhesion (adhesion with adhesive or solvent), fusion (fusion by heat, high frequency, ultrasound or the like) and the like.

The cleaning brush 1 having such a structure is inserted into the cylinder portion 163 such that the grasping portion 3 is inserted at first from the opening 165 toward the opening 166 and then the cleaning brush 1 is further pushed until the grasping portion 3 protrudes from the opening 166, after which the grasping portion 3 is pulled to remove the entire cleaning brush 1 from the opening 166, whereby the cleaning of the suction channel 16 is completed.

In this regard, it is preferred that the protruding portion 5 is provided with friction increase means for increasing friction between the protruding portion 5 and the inner wall 167 of the suction channel 16. The friction increase means enables to prevent the protruding portion 5 from suddenly jumping out of the suction channel 16 when removing the entire cleaning brush 1 from the endoscope 10, thus making it possible to prevent or suppress splash of dirt or cleaning liquid on a user more reliably.

The friction increase means is not particularly limited to any specific one. It may be, for example, fine irregularities of the protruding portion 5 or a rubber coating provided on the outer surface 51 of the protruding portion 5. Such friction increase means can be provided in the protruding portion 5 easily and reliably by applying rough surface treatment to the outer surface 51 or subjecting the outer surface 51 to a rubber coating treatment.

In the above embodiment, the description has been made with regard to the case where the cleaning brush 1 is inserted into the endoscope 10 from the opening 165 toward the opening 166, the present invention is not limited thereto. The cleaning brush 1 may be inserted into the endoscope 10 from an opening portion 168 provided in a branch portion which is branched from the suction channel 16 toward the opening 166.

### <SECOND EMBODIMENT>

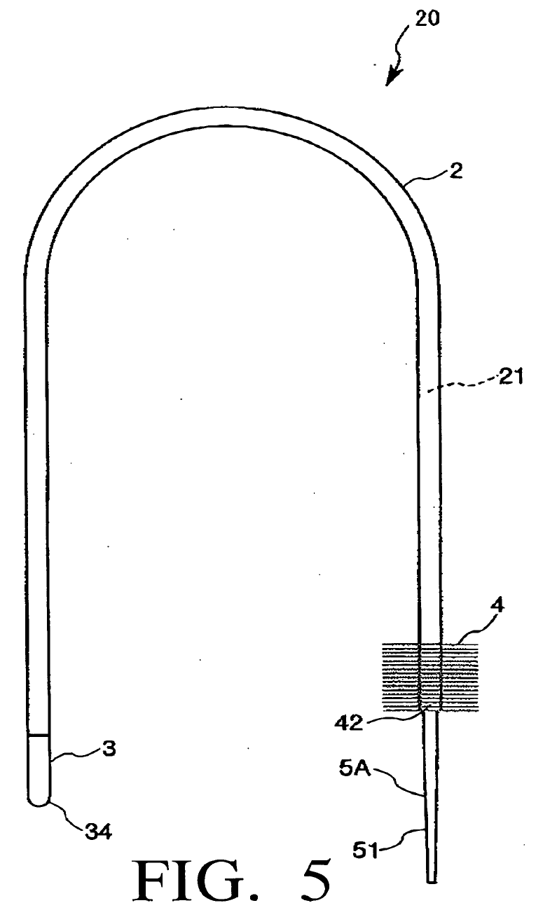

FIG. 5 is a plane view showing the second embodiment of the cleaning brush for endoscopes according to the present invention. In this regard, it is to be noted that in a cleaning brush 20 shown in FIG. 5 an end portion having a brush portion is referred to as “a tip end” and the other end is referred to as “a base end” in the following description.

Hereinafter, the second embodiment of the cleaning brush 20 according to the present invention will be described with reference to FIG. 5 by focusing the difference between the second embodiment and the first embodiment described above, and therefore a description of overlapping points will be omitted.

The cleaning brush 20 of the second embodiment is the same as the cleaning brush 1 of the first embodiment except for the shape of the protruding portion.

As shown in FIG. 5, an outer diameter of a protruding portion 5A is gradually reduced toward the tip end thereof. Namely, an outer surface 51 of the protruding portion 5A is formed into a tapered shape. This allows the protruding portion 5 to have sufficient bendability (flexibility) so as to be able to make contact with the inner wall 167 of the suction channel 16 softly when removing the brush portion 4 from the opening 166. Accordingly, it is possible to prevent or suppress the swinging or springing of the brush portion 4 more reliably, namely it is possible to prevent or suppress splash of dirt or cleaning liquid more reliably.

### <THIRD EMBODIMENT>

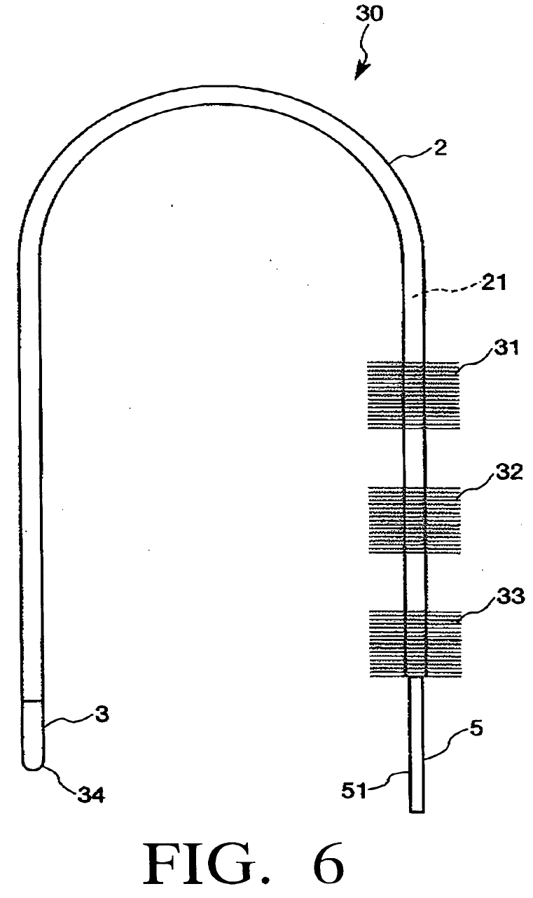

FIG. 6 is a plane view showing the third embodiment of the cleaning brush for endoscopes. In this regard, it is to be noted that in a cleaning brush 30 shown in FIG. 6 an end portion having brush portions is referred to as “a tip end” and the other end is referred to as “a base end” in the following description.

Hereinafter, the third embodiment of the cleaning brush for endoscopes according to the present invention will be described with reference to FIG. 6 by focusing the difference between the third embodiment and the aforementioned embodiments, and therefore a description of overlapping points will be omitted.

The cleaning brush 30 of the third embodiment is the same as the cleaning brush 1 of the first embodiment except for the number of the brush portions provided on the body portion 2.

As shown in FIG. 6, a cleaning brush 30 has three brush portions 31, 32 and 33. These brush portions 31, 32 and 33 are arranged on the body portion 2 along a longitudinal direction thereof with a predetermined space therebetween.

By providing such a plurality of brush portions, if the cleaning brush 30 is inserted into the channel 16 only once, the same effect can be obtained as the case where the cleaning brush 1 having only one brush portion 4 described above is repeatedly inserted into the channel more than once. This makes it possible to reduce the number of insertion times of the cleaning brush 30, whereby enabling to clean an endoscope with less effort.

In this regard, it is to be noted that the brush portion 33 positioned nearest to the tip end of the cleaning brush 30 in the third embodiment corresponds to the brush portion 4 of the cleaning brush 1 in the first embodiment.

Further, the number of brush portions is not limited to three, and it may be two, or four or more, for example.

### <FOURTH EMBODIMENT>

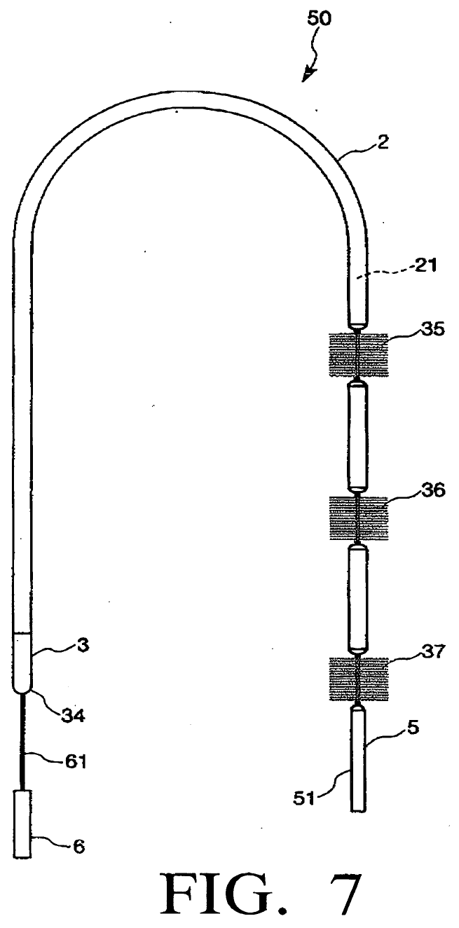

FIG. 7 is a plane view showing the fourth embodiment of the cleaning brush for endoscopes. In this regard, It is to be noted that in a cleaning brush 50 for endoscopes shown in FIG. 7 an end portion having brush portions is referred to as “a tip end” and the other end is referred to as “a base end” in the following description.

Hereinafter, the fourth embodiment of the cleaning brush for endoscopes according to the present invention will be described with reference to FIG. 7 by focusing the difference between the fourth embodiment and the aforementioned embodiments, and therefore a description of overlapping points will be omitted.

The cleaning brush 50 of the fourth embodiment is the same as the cleaning brush 30 of the third embodiment except for the structure of the brush portions and the provision of a colored portion.

Each of brush portions 35, 36 and 37 of the cleaning brush 50 is constructed such that a large number of metal wires are twisted together to form a wire string as a core of each brush portion, and at the same time of twisting the metal wires, a large number of line elements which form bristles of the brush portion are inserted between the metal wires into a direction perpendicular thereto, and the metal wires are twisted in this state to thereby form the brush portion. Further, in each of the brush portions, both ends of the wire string (the core of the brush portion) are secured to the body portion 2 or protruding portion 5.

According to the brush portions having such a structure, each line element of the bristles is firmly secured between the wires, thus making it possible to prevent the bristles from being detached or fallen out from the cleaning brush 50 and remaining inside the channel of the endoscope more reliably.

As shown in FIG. 7, the cleaning brush 50 is provided with a colored portion 6. The colored portion 6 is connected to the base end 34 of the cleaning brush 50 through a connecting portion 61 which is made of, for example, a resin.

The provision of the colored portion 6 enables a user to confirm that the base end portion of the cleaning brush 50 has reached the opening 166 immediately when the colored portion 6 protrudes from the opening 166.

In this regard, it is to be noted that although the cleaning brush for endoscopes according to the present invention has been described based on the embodiments shown in the drawings, the present invention is not limited thereto. Each of the portions constituting the cleaning brush for endoscopes may be replaced by one which can provide the same function.

For example, the protruding portion 5 in the third embodiment may be formed into the same shape as that of the protruding portion 5A in the second embodiment.

Further, each of the brush portions in the first, second and third embodiments may be constructed by the same method as the brush portions in the fourth embodiment.

Furthermore, it is not necessary to provide the grasping portion in the body portion as a separate member and it may be integrally formed with the body portion.

Moreover, each of the brush portions of the fourth embodiment may be provided on the body portion in the same manner as the first embodiment so that a base portion of each of the line elements is fixed to the body portion.

Yet further, it is not necessary for the brush portion to be impregnated with cleaning liquid in advance of being inserted into the channel. Cleaning liquid may be injected into the channel before inserting the brush portion thereinto.

Yet further, it is not necessary to provide the protruding portion in the body portion as a separate member and it may be integrally formed with the body portion. In a case where the protruding portion is integrally formed with the body portion, a bonding process between the protruding portion and the body portion can be omitted.

Finally, it is also to be understood that the present disclosure relates to subject matter contained in Japanese Patent Application No. 2005-003224 (filed on Jan. 7, 2005) which is expressly incorporated herein by reference in its entirety.

What is claimed is:

1. A cleaning brush for endoscopes for cleaning a channel formed inside an endoscope, comprising:
an elongated body portion having flexibility so as to bend along an inner wall of the channel when being inserted into the channel, the body portion having a tip end and a base end;
at least one brush portion provided on the body portion at the side of the tip end thereof; and
a protruding portion provided on the body portion so as to protrude from the tip end of the body portion in a longitudinal direction thereof, the protruding portion being adapted to make contact with the inner surface of the channel to prevent or suppress the brush portion from swinging or springing when the brush portion is removed from the channel.

2. The cleaning brush for endoscopes as claimed in claim 1, wherein the at least one brush portion includes a plurality of brush portions, in which the length of the protruding portion is substantially equal to or longer than the length of one of the brush portions which is positioned nearest to the tip end among the plurality of brush portions.

3. The cleaning brush for endoscopes as claimed in claim 2, wherein the length of the protruding portion is in the range of 100 to 1000% of the length of the brush portion positioned nearest to the tip end.

4. The cleaning brush for endoscopes as claimed in claim 1, wherein the average outer diameter of the protruding portion is smaller than that of the body portion.

5. The cleaning brush for endoscopes as claimed in claim 1, wherein the outer diameter of the protruding portion is reduced gradually toward the tip end thereof.

6. The cleaning brush for endoscopes as claimed in claim 1, wherein stiffness of the protruding portion is lower than that of the body portion.

7. The cleaning brush for endoscopes as claimed in claim 1, wherein at least a part of the protruding portion is integrally formed with the body portion.

8. The cleaning brush for endoscopes as claimed in claim 1, wherein the protruding portion is provided with friction increase means for increasing friction between the protruding portion and the inner surface of the channel.

9. The cleaning brush for endoscopes as claimed in claim 8, wherein the friction increase means is comprised of fine irregularities or a rubber coating provided on the outer surface of the protruding portion.

10. The cleaning brush for endoscopes as claimed in claim 1, wherein the base end portion of the body portion functions as a grasping portion to be grasped by a user.
